(19) United States
(12) Patent Application Publication
(10) Pub. No.: US 2026/0321916 A1
(43) Pub. Date: Oct. 15, 2026

(54) BATTERY CELL AND BATTERY DEVICE INCLUDING THE SAME

(71) Applicant: SK On Co., Ltd., Seoul (KR)

(72) Inventor: Jong Hyeok LEE, Daejeon (KR)

(21) Appl. No.: 19/461,726

(22) Filed: Jan. 28, 2026

(30) Foreign Application Priority Data
Mar. 25, 2025 (KR) 10-2025-0038012

(51) Int. Cl. H01M 50/54; H01M 50/178; H01M 50/184; H01M 50/186; H01M 50/105

(52) U.S. Cl. CPC H01M 50/54; H01M 50/178; H01M 50/184; H01M 50/186; H01M 50/105

(57) ABSTRACT

The present disclosure provides a battery cell including: an electrode assembly including a plurality of electrode plates arranged in a first direction and a plurality of bundles of non-coated portions, drawn from the plurality of electrode plates; a cell case having the electrode assembly accommodated therein; and an electrode lead electrically connected to the plurality of bundles of non-coated portions, which include a bundle of first cathode non-coated portions, a bundle of second cathode non-coated portions, a bundle of first anode non-coated portions, and a bundle of second anode non-coated portions, the electrode lead includes first and second cathode leads and first and second anode leads respectively connected to the bundle of first cathode non-coated portions, the bundle of second cathode non-coated portions, the bundle of first anode non-coated portions, and the bundle of second anode non-coated portions, and the electrode lead is exposed externally of the cell case.

### CROSS-REFERENCE TO RELATED APPLICATIONS

This patent document claims the priority and benefits of Korean Patent Application No. 10-2025-0038012 filed on Mar. 25, 2025, the disclosure of which is incorporated herein by reference in its entirety.

### TECHNICAL FIELD

The present disclosure relates to a battery cell (secondary battery) including a plurality of electrode leads and a battery device including the same.

### BACKGROUND

Unlike primary batteries, secondary batteries may be charged with and discharged of electricity, so secondary batteries may be used as a power source in devices within various fields such as digital cameras, mobile devices, electric vehicles, and energy storage systems (ESS). There are several types of secondary batteries, including lithium secondary batteries, nickel-cadmium batteries, and nickel-metal hydride batteries, and may be manufactured as flexible pouch-type battery cells or rigid can-type battery cells. Can-type battery cells are classified into prismatic battery cells, cylindrical battery cells, and coin-type battery cells depending on the external shape thereof, and each shape may be variously applied according to the device and environment in which the can-type battery cell is used.

A plurality of battery cells may be arranged in a certain pattern to form a battery module or a battery pack, which can be used for various purposes such as electric vehicles and energy storage systems (ESS).

### SUMMARY

A secondary battery may experience swelling and shrinkage during a charging and discharging process, which may cause a change in a thickness of an electrode assembly. Due to the change in the thickness, stress applied to a non-coated portion disposed on the outside of the electrode assembly may be relatively greater than stress applied to a non-coated portion disposed on the inside of the electrode assembly, which may result in short-circuits in the non-coated portion disposed on the outside of the electrode assembly.

In addition, as the electrode assembly becomes thicker, bending of the non-coated portion disposed on the outside of the electrode assembly may be more severe, and in order to prevent this, when a non-coated portion is gathered at a gentle angle, a separation distance, a gap from an end of the electrode assembly in a length direction to a bundle of non-coated portions may increase, so that the energy density of the battery cell may decrease. In addition, heat generation may be concentrated around electrode leads or in a path through which current flows within the battery cell, and such localized heat generation concentration may cause a decrease in the stability of the battery cell.

According to an aspect of the present disclosures, a battery cell and a battery device including the same that can limit or prevent short-circuits in a non-coated portion, may be provided.

According to an aspect of the present disclosure, a battery cell having improved energy density and a battery device including the same, may be provided.

According to an aspect of the present disclosure, a battery cell and a battery device including the same that can alleviate localized heat generation concentration inside an electrode assembly, may be provided.

The battery cell and the battery device including the same of the present disclosure may be widely applied to green technology fields such as electric vehicles, battery charging stations, solar power generation, wind power generation using other batteries, and the like. In addition, the battery cell and the battery device including the same of the present disclosure may be used in eco-friendly electric vehicles, hybrid vehicles, or the like, to prevent climate change by suppressing air pollution and greenhouse gas emissions.

According to the present disclosure, a battery cell may include: an electrode assembly including a plurality of electrode plates arranged in a first direction, and a plurality of bundles of non-coated portions, drawn from the plurality of electrode plates; a cell case having the electrode assembly accommodated therein; and an electrode lead electrically connected to the plurality of bundles of non-coated portions, wherein the plurality of bundles of non-coated portions include a bundle of first cathode non-coated portions, a bundle of second cathode non-coated portions, a bundle of first anode non-coated portions, and a bundle of second anode non-coated portions, the electrode lead includes a first cathode lead connected to the bundle of first cathode non-coated portions, a second cathode lead connected to the bundle of second cathode non-coated portions, a first anode lead connected to the bundle of first anode non-coated portions, and a second anode lead connected to the bundle of second anode non-coated portions, and the first cathode lead, the second cathode lead, the first anode lead, and the second anode lead may be exposed externally of the cell case.

In an embodiment, the bundle of first cathode non-coated portions and the bundle of second cathode non-coated portions may be formed at different heights in the first direction, and the bundle of first anode non-coated portions and the bundle of second anode non-coated portions may be formed at different heights in the first direction.

In an embodiment, in a second direction, a length direction of the cell case, the bundle of first cathode non-coated portions and the bundle of second cathode non-coated portions may be disposed on one side of the electrode assembly, and in the second direction, the bundle of first anode non-coated portions and the bundle of second anode non-coated portions may be disposed on the other side of the electrode assembly.

In an embodiment, when viewed in the first direction, the bundle of first cathode non-coated portions and the bundle of second cathode non-coated portions may be formed to be spaced apart from each other in a third direction, a width direction of the cell case, and when viewed in the first direction, the bundle of first anode non-coated portions and the bundle of second anode non-coated portions may be formed to be spaced apart from each other in the third direction.

In an embodiment, when viewed in the first direction, the first cathode lead and the second cathode lead may be disposed to not overlap each other, and the first anode lead and the second anode lead may be disposed to not overlap each other.

In an embodiment, when viewed in the first direction, when a straight-line distance from the bundle of first cathode non-coated portions to the bundle of first anode non-coated portions is D1, a straight-line distance from the bundle of second cathode non-coated portions to the bundle of second anode non-coated portions is D2, and a length of the electrode assembly is D, the following formula may be satisfied, D1 > D, D2 > D.

In an embodiment, the cell case may include an electrode receiving portion in which the electrode assembly is received, and a sealing portion sealing at least a portion of a circumference of the electrode receiving portion, wherein the sealing portion may include a first sealing portion sealing a surface in which the electrode lead is disposed, and a second sealing portion sealing a surface in which the electrode lead is not disposed, and the first sealing portion may include an inclined portion forming a slope.

In an embodiment, the inclined portion may be formed between the first cathode lead and the second cathode lead or between the first anode lead and the second anode lead.

In an embodiment, the inclined portion may be formed to be spaced apart from the first cathode lead and the second cathode lead or the first anode lead and the second anode lead.

According to the present disclosure, a battery cell may include: a first electrode assembly including a plurality of electrode plates arranged in a first direction, and a bundle of first cathode non-coated portions and a bundle of first anode non-coated portions, drawn from the plurality of electrode plates; a second electrode assembly including a plurality of electrode plates arranged in a first direction, and a bundle of second cathode non-coated portions and a bundle of second anode non-coated portions, drawn from the plurality of electrode plates; and a cell case having the first electrode assembly and the second electrode assembly accommodated therein, wherein the first electrode assembly and the second electrode assembly may be arranged in the first direction, and the bundle of first cathode non-coated portions and the bundle of first anode non-coated portions of the first electrode assembly may be electrically connected to a first cathode lead and a first anode lead, respectively, the bundle of second cathode non-coated portions and the bundle of second anode non-coated portions of the second electrode assembly may be electrically connected to a second cathode lead and a second anode lead, respectively, and the first cathode lead, the second cathode lead, the first anode lead, and the second anode lead may be exposed externally of the cell case.

In an embodiment, the first cathode lead and the second cathode lead may be exposed externally from one side of the cell case, in a second direction, a length direction of the cell case, and the first anode lead and the second anode lead may be exposed externally from the other side of the cell case in the second direction.

In an embodiment, when viewed in the first direction, when a straight-line distance from the bundle of first cathode non-coated portions to the bundle of first anode non-coated portions is D1, a straight-line distance from the bundle of second cathode non-coated portions to the bundle of second anode non-coated portions is D2, and a length of the first electrode assembly and the second electrode assembly is D, the following formula may be satisfied, D1 > D, D2 > D.

In an embodiment, the first cathode lead and the first anode lead may be exposed externally from one side of the cell case, in a second direction, a length direction of the cell case, and the second cathode lead and the second anode lead may be exposed externally from the other side of the cell case in the second direction.

According to the present disclosure, a battery cell may include: a cell assembly including a plurality of battery cells; and a housing accommodating the cell assembly, wherein at least one of the plurality of battery cells includes: an electrode assembly including a plurality of electrode plates arranged in a first direction, and a plurality of bundles of non-coated portions, drawn from the plurality of electrode plates; a cell case having the electrode assembly accommodated therein; and an electrode lead electrically connected to the plurality of bundles of non-coated portions, the plurality of bundles of non-coated portions include a bundle of first cathode non-coated portions, a bundle of second cathode non-coated portions, a bundle of first anode non-coated portions, and a bundle of second anode non-coated portions, the electrode lead includes a first cathode lead connected to the bundle of first cathode non-coated portions, a second cathode lead connected to the bundle of second cathode non-coated portions, a first anode lead connected to the bundle of first anode non-coated portions, and a second anode lead connected to the bundle of second anode non-coated portions, and the first cathode lead, the second cathode lead, the first anode lead, and the second anode lead may be exposed externally of the cell case.

### BRIEF DESCRIPTION OF DRAWINGS

Certain aspects, features, and advantages of the present disclosure are illustrated by the following detailed description with reference to the accompanying drawings.

FIG. 1 is a perspective view illustrating a battery cell according to a first embodiment.

FIG. 2 is a perspective view illustrating the interior of a cell case of the battery cell illustrated in FIG. 1.

FIG. 3 is a cross-sectional view taken along line I-I’ illustrated in FIG. 2.

FIG. 4 is a top view of the interior of a cell case of the battery cell illustrated in FIG. 2, and is a diagram illustrating a flow of current.

FIG. 5 is a top view of the interior of a cell case of the battery cell according to a second embodiment, and is a diagram illustrating a flow of current.

FIG. 6 is a top view of a battery cell according to a third embodiment.

FIG. 7 is a side view of the battery cell illustrated in FIG. 6.

FIG. 8 is a side view of a battery cell according to a fourth embodiment.

FIG. 9 is a perspective view illustrating a first electrode assembly and a second electrode assembly according to an embodiment.

FIG. 10 is a perspective view illustrating a first electrode assembly and a second electrode assembly according to another embodiment.

FIG. 11 is an exploded perspective view of a battery module according to an embodiment.

FIG. 12 is an exploded perspective view of a battery pack according to an embodiment.

### DETAILED DESCRIPTION

Hereinafter, the present disclosure will be described in detail with reference to the attached drawings. However, these are merely examples, and the present disclosure is not limited to the specific embodiments described as examples.

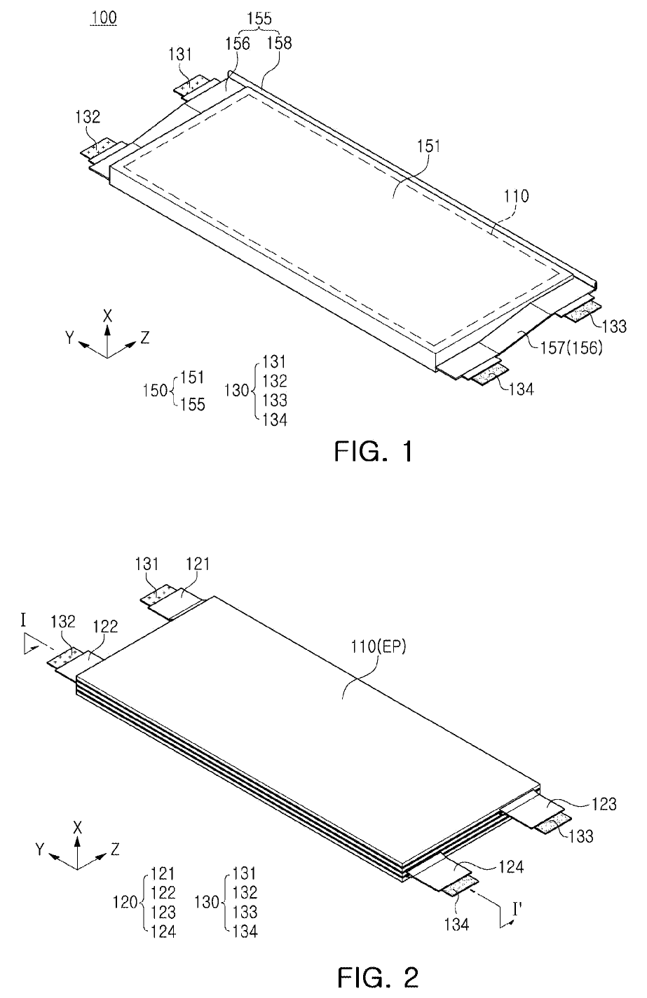

First, a battery cell 100 according to a first embodiment of the present disclosure will be described with reference to FIG. 1, and an electrode assembly 110 and an electrode lead 130 according to the first embodiment will be described in more detail with reference to FIGS. 2 to 4.

FIG. 1 is a perspective view illustrating a battery cell 100 according to a first embodiment.

Referring to FIG. 1, the battery cell 100 according to the first embodiment of the present disclosure may include an electrode assembly 110, a cell case 150, and an electrode lead 130.

The battery cell 100 of the present disclosure may be formed as a secondary battery to be charged and discharged. The battery cell 100 may have a form in which an electrode assembly 110 and an electrolyte are accommodated within a cell case 150. As an example, the battery cell 100 may be formed of a lithium ion (Li-ion) battery or a nickel metal hydride (Ni-MH) battery, but the type is not limited thereto.

The battery cell 100 may have a form in which an electrode assembly 110 and an electrolyte are accommodated within a cell case 150 forming an exterior material.

In the present disclosure, the battery cell 100 is exemplified as a pouch-type cell, but can also be applied to other types of battery cells 100, such as a square cell.

The battery cell 100 according to a first embodiment may include an electrode assembly 110 including a plurality of electrode plates (EP of FIG. 2) arranged in a first direction (X) and a plurality of bundles of non-coated portions (120 in FIG. 2), drawn from the plurality of electrode plates EP, a cell case 150 having the electrode assembly 110 accommodated therein, and an electrode lead 130 electrically connected to the plurality of bundles of non-coated portions 120.

In the battery cell 100 of the present disclosure, the first direction (X) refers to a direction in which electrode plates EP are arranged. In other words, the first direction (X) refers to a height direction (or thickness direction) of the cell case 150. In the battery cell 100 of the present disclosure, a second direction (Y) refers to a length direction of the cell case 150, and a third direction (Z) refers to a width direction of the cell case 150. In this case, the length direction of the cell case 150 refers to a longer direction among a horizontal length and a vertical length, excluding the height (thickness) of the cell case 150, and the width direction of the cell case 150 refers to the remaining directions. Each of the first direction (X), the second direction (Y), and the third direction (Z) is perpendicular to each other.

The electrode assembly 110 may include a plurality of electrode plates EP arranged in the first direction (X) and a plurality of non-coated portions, drawn from the plurality of electrode plates EP. In addition, the electrode assembly 110 may include a separator.

The electrode plate EP may include a cathode plate and an anode plate. A separator may be interposed between the cathode plate and the anode plate to electrically insulate the same. The electrode assembly 110 may have various forms, such as a winding type, a stacking type, a zigzag-folding type, and a stack-folding type.

The electrode plates EP are arranged in the first direction (X), which means that the plurality of electrode plates EP are overlapped and stacked or disposed side by side in the thickness direction of the cell case 150 in a state in which wide surfaces of the plurality of electrode plates EP face each other. For example, the electrode assembly 110 may include a plurality of electrode plates EP stacked in a first direction (X).

The electrode assembly 110 may have a shape in which a cathode plate and an anode plate are stacked with a separator interposed therebetween. The cathode plate and the anode plate may have a structure in which an active material is applied to a metal foil. Each of the cathode plate and the anode plate may include a coated portion coated with an active material and a non-coated portion not coated with an active material. The bundle of non-coated portions (120 in FIG. 2) may extend from the electrode plates EP in the second direction (Y). Each of the plurality of cathode plates and the plurality of anode plates may include a non-coated portion. The non-coated portion may include a cathode non-coated portion, drawn from the cathode plate and an anode non-coated portion, drawn from the anode plate. The non-coated portion may be connected to the electrode lead 130 so that portions having the same polarities contact each other.

At least a portion of the non-coated portions may extend from the coated portion and be exposed externally of the separator to form a bundle of non-coated portions (120 in FIG. 2). For example, a plurality of cathode non-coated portions may be gathered to form a bundle of cathode non-coated portions, and a plurality of anode non-coated portions may be gathered to form a plurality of bundles of anode non-coated portions. The bundle of non-coated portions (120 in FIG. 2) may be connected to the electrode lead 130 so that portions having the same polarities contact each other. The bundle of non-coated portions (120 in FIG. 2) may function as an electrode tab.

The cell case 150 may have the electrode assembly 110 accommodated therein. The cell case 150 may form at least a portion of the exterior of the battery cell 100. The cell case 150 may include an electrode receiving portion 151 in which the electrode assembly 110 is received, and a sealing portion 155 sealing at least a portion of a circumference of the electrode receiving portion 151. As an example, the cell case 150 may be formed of a pouch film, but an embodiment thereof is not limited thereto.

The electrode receiving portion 151 may provide a receiving space in which an electrode assembly 110 and an electrolyte are received. The sealing portion 155 may be formed by bonding at least a portion of the circumference of the cell case 150. The sealing portion 155 may be formed in the form of a flange extending outwardly from the electrode receiving portion 151, which is formed in the form of a container, and may be disposed along at least a portion of an outer peripheral portion of the electrode receiving portion 151. In an embodiment, the sealing portion 155 may seal at least a portion of the electrode lead 130. A thermal fusion method may be used for bonding the sealing portion 155, but an embodiment thereof is not limited thereto.

The electrode lead 130 may be electrically connected to the electrode assembly 110. The electrode lead 130 may be electrically connected to a plurality of bundles of non-coated portions (120 in FIG. 2). The electrode lead 130 may include a first cathode lead 131 and a second cathode lead 132 connected to a bundle of cathode non-coated portions of the cathode plate, and a first anode lead 133 and a second anode lead 134 connected to a bundle of anode non-coated portions of the anode plate. The electrode lead 130 may be exposed externally through a portion of the sealing portion 155. For example, the electrode lead 130 may have a shape extending from the electrode assembly 110 in the second direction (Y) and may be exposed externally of the sealing portion 155. A direction in which the electrode lead 130 is positioned may be changed in various manners, depending on the specifications of the battery cell 100.

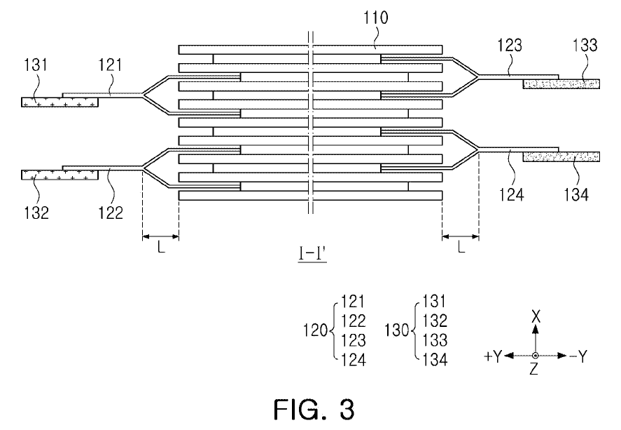

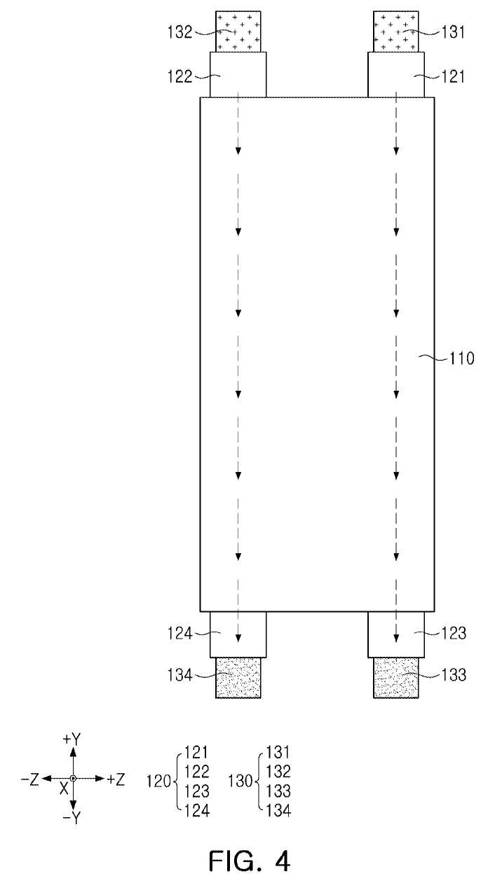

FIG. 2 is a perspective view illustrating the interior of a cell case 150 of the battery cell 100 illustrated in FIG. 1, FIG. 3 is a cross-sectional view taken along line I-I’ illustrated in FIG. 2, and FIG. 4 is a top view illustrating the interior of a cell case 150 of the battery cell 100 illustrated in FIG. 2, and is a diagram illustrating a flow of current.

A plurality of bundles of non-coated portions 120 may include a bundle of first cathode non-coated portions 121, a bundle of second cathode non-coated portions 122, a bundle of first anode non-coated portions 123, and a bundle of second anode non-coated portions 124.

Referring to FIGS. 2 and 3 together, a plurality of bundles of non-coated portions may be formed. For example, a portion of the cathode non-coated portions may be gathered to form a bundle of first cathode non-coated portions 121, and the remaining cathode non-coated portions may be gathered to form a bundle of second cathode non-coated portions 122. Alternatively, a portion of the anode non-coated portions may be gathered to form a bundle of first anode non-coated portions 123, and the remaining anode non-coated portions may be gathered to form a bundle of second anode non-coated portions 124. However, this is for illustrative purposes only, and the number of the bundle of cathode non-coated portions or the bundle of anode non-coated portions is not limited to two, and three or more thereof may be formed depending on the thickness or design conditions of the electrode assembly 110.

During the process of forming a bundle of non-coated portions, each non-coated portion may be gathered toward the center in a first direction (X). In this case, greater stress may be applied to a non-coated portion on the outside of the electrode assembly 110, compared to a non-coated portion on the inside of the electrode assembly 110. In addition, the non-coated portion on the outside of the electrode assembly 110 may be likely to have to be folded or bent at a relatively steeper angle. When the electrode assembly 110 is thick, bending of the non-coated portion disposed on the outside of the electrode assembly 110 may become more severe. To minimize the bending of the non-coated portion, when the non-coated portion disposed on the outside of the electrode assembly 110 is designed to be bent at a gentle angle, a separation distance L, a gap from an end of the electrode assembly 110 in a length direction to a bundle of non-coated portions, may increase, so that there may be a possibility that the energy density of the battery cell 100 may decrease.

When a plurality of bundles of non-coated portions are formed, the stress applied to the non-coated portion disposed on the outside of the electrode assembly 110 may be effectively reduced while maintaining the thickness of the electrode assembly 110. For example, in the case in which two bundles of non-coated portions are formed, the bundle of first cathode non-coated portions 121 may be gathered in a first central region, and the bundle of second cathode non-coated portions 122 may be gathered in a second central region, so that a difference in the degrees of stress applied to the non-coated portion disposed on the outside of each bundle of non-coated portions and the non-coated portion disposed on the inside thereof may be reduced. In addition, bending of the non-coated portion disposed on the outside of each bundle of non-coated portions may be minimized, and the energy density of the battery cell 100 may be improved by reducing the separation distance (L). In addition, by reducing a difference in the degrees of stress applied to the non-coated portion disposed on the outside of each bundle of non-coated portions and the non-coated portion disposed on the inside thereof, damage or short-circuits in the non-coated portion may be prevented, and the stability of the battery cell 100 may be improved. However, the location in which the bundle of non-coated portions is gathered is not limited to a central region of the bundle of non-coated portions.

The electrode lead 130 may include a first cathode lead 131 connected to the bundle of first cathode non-coated portions 121, a second cathode lead 132 connected to the bundle of second cathode non-coated portions 122, a first anode lead 133 connected to the bundle of first anode non-coated portions 123, and a second anode lead 134 connected to the bundle of second anode non-coated portions 124, and the first cathode lead 131, the second cathode lead 132, the first anode lead 133, and the second anode lead 134 may be exposed externally of the cell case 150.

Each non-coated portion bundle may be electrically connected to an individual electrode lead 130. In other words, a single non-coated portion bundle may be electrically connected to a single electrode lead 130. For example, the bundle of first cathode non-coated portions 121 may be connected to the first cathode lead 131, the bundle of second cathode non-coated portions 122 may be connected to the second cathode lead 132, the bundle of first anode non-coated portions 123 may be connected to the first anode lead 133, and the bundle of second anode non-coated portions 124 may be connected to the second anode lead 134, respectively. Thereby, each non-coated portion bundle may form an independent electrical path.

Each of the first cathode lead 131, the second cathode lead 132, the first anode lead 133, and the second anode lead 134 may be exposed externally of the cell case 150. That is, the first cathode lead 131, the second cathode lead 132, the first anode lead 133, and the second anode lead 134 may be individually exposed externally through the sealing portion 155. There may be at least four electrode leads 130 exposed externally of the cell case 150. For example, the electrode lead 130 exposed externally of the cell case 150 may include two or more cathode leads and two or more anode leads. When the first cathode lead 131, the second cathode lead 132, the first anode lead 133, and the second anode lead 134 are individually exposed externally of the cell case 150, the flexibility of the electrical connection can be increased and a degree of design freedom can be improved.

When each of the bundle of first cathode non-coated portions 121 and the bundle of second cathode non-coated portions 122 is electrically connected to the first cathode lead 131 and the second cathode lead 132, current flowing through each electrode lead 130 may be dispersed, so that a current concentration phenomenon may be reduced. In addition, generation of heat concentrated near the electrode lead 130 may be dispersed. Each of the first cathode lead 131, the second cathode lead 132, the first anode lead 133, and the second anode lead 134 may be disposed to correspond to positions of a bundle of first cathode non-coated portions 121, a bundle of second cathode non-coated portions 122, a bundle of first anode non-coated portions 123, and a bundle of second anode non-coated portions 124, to be described below.

A first cathode lead 131, a second cathode lead 132, a first anode lead 133, and a second anode lead 134 may be disposed to be spaced apart from each other, to prevent electrical interference therebetween. The first cathode lead 131, the second cathode lead 132, the first anode lead 133, and the second anode lead 134 may be disposed so as not to contact each other. For example, when viewed in a first direction (X), the first cathode lead 131 and the second cathode lead 132 may be disposed so as not to overlap each other, and the first anode lead 133 and the second anode lead 134 may be disposed so as not to overlap each other. Based on the direction of FIG. 4, the first cathode lead 131 may be disposed on a right side (+Z) of a third direction (Z) of the electrode assembly 110, and the second cathode lead 132 may be disposed on a left side (-Z) of the third direction (Z) of the electrode assembly 110. By disposing the first cathode lead 131 and the second cathode lead 132 or the first anode lead 133 and the second anode lead 134 so as not to overlap each other, electrical interference between the electrode leads 130 may be prevented and localized concentrated heat generation can be alleviated.

The bundle of first cathode non-coated portions 121 and the bundle of second cathode non-coated portions 122 may be formed at different heights in the first direction (X), and the bundle of first anode non-coated portions 123 and the bundle of second anode non-coated portions 124 may be formed at different heights in the first direction (X).

For example, based on a center in the height direction (first direction) (X) of the electrode assembly 110, cathode non-coated portions located on the upper side may be gathered to form a bundle of first cathode non-coated portions 121, and cathode non-coated portions located on the lower side may be gathered to form a bundle of second cathode non-coated portions 122. However, the number of cathode non-coated portions forming the bundle of first cathode non-coated portions 121 and the number of cathode non-coated portions forming the bundle of second cathode non-coated portions 122 do not necessarily have to be the same, and may be appropriately changed depending on the design. Likewise, thicknesses of the bundle of first cathode non-coated portions 121 and the bundle of second cathode non-coated portions 122 do not necessarily have to be the same, and may be appropriately changed depending on the design.

In a second direction (Y), a length direction of the cell case 150, the bundle of first cathode non-coated portions 121 and the bundle of second cathode non-coated portions 122 may be disposed on one side of the electrode assembly 110, and in the second direction (Y), the bundle of first anode non-coated portions 123 and the bundle of second anode non-coated portions 124 may be disposed on the other side of the electrode assembly 110.

That is, a bundle of cathode non-coated portions and a bundle of anode non-coated portions may be respectively disposed on both sides of the electrode assembly 110 in the length direction. For example, based on the direction illustrated in FIG. 4, the bundle of first cathode non-coated portions 121 and the bundle of second cathode non-coated portions 122 may be disposed in a +Y direction, and the first anode non-coated portion 123 and the second anode non-coated portion 124 may be disposed in a -Y direction. When disposed as described above, one side thereof is formed as a cathode and the other side thereof is formed as an anode, so it can be advantageous in designing for connection with the electrode lead 130 and electrical connection with an external device.

Referring to FIGS. 2 and 4 together, when viewed in the first direction (X), the bundle of first cathode non-coated portions 121 and the bundle of second cathode non-coated portions 122 may be formed to be spaced apart from each other in a third direction (Z), a width direction of the cell case 150, and when viewed in the first direction (X), the bundle of first anode non-coated portions 123 and the bundle of second anode non-coated portions 124 may be formed to be spaced apart from each other in the third direction (Z).

That is, the bundle of first cathode non-coated portions 121 and the bundle of second cathode non-coated portions 122 may be disposed at a constant interval in the third direction (Z), and in the same manner, the bundle of first anode non-coated portions 123 and the bundle of second anode non-coated portions 124 may be disposed at a constant interval in the third direction (Z). This minimizes thermal and mechanical influences between respective bundles of non-coated portions, and in particular, generation of heat generated around the bundle of non-coated portions during the charging and discharging process may be distributed more evenly rather than being concentrated in a specific area. In addition, when the respective bundles of non-coated portions are formed to be spaced apart from each other in the third direction (Z), a process of gathering the non-coated portions to form bundles of non-coated portions may be performed more smoothly by preventing interference between the bundles of non-coated portions. That is, since the bundles of non-coated portions are not densely packed and have sufficient intervals, they can be aligned to a desired position without obstacles during the process of forming the bundle of non-coated portions, thereby improving assembly precision.

Meanwhile, when viewed in the first direction (X), the bundle of first cathode non-coated portions 121 and the bundle of first anode non-coated portions 123 may be disposed vertically in the second direction (Y). Alternatively, the bundle of second cathode non-coated portions 122 and the bundle of second anode non-coated portions 124 may be disposed vertically in the second direction (Y). For example, based on the direction illustrated in FIG. 4, if the bundle of first cathode non-coated portions 121 is located on a right side in a +Y direction, the bundle of first anode non-coated portions 123 may also be located on a left side in a -Y direction. If the bundle of second cathode non-coated portions 122 is located on a left side in the +Y direction, the bundle of second anode non-coated portions 123 may be located on a left side in the -Y direction. When the bundle of non-coated portions are disposed as described above, heat generation of the electrode assembly 110 due to concentration of current may be prevented. In other words, a distance from the bundle of first cathode non-coated portions 121 to the bundle of first anode non-coated portions 123 may be equal to a length of the electrode assembly 110. The distance from the bundle of second cathode non-coated portions 122 to the bundle of second anode non-coated portions 124 may be equal to the length of the electrode assembly 110.

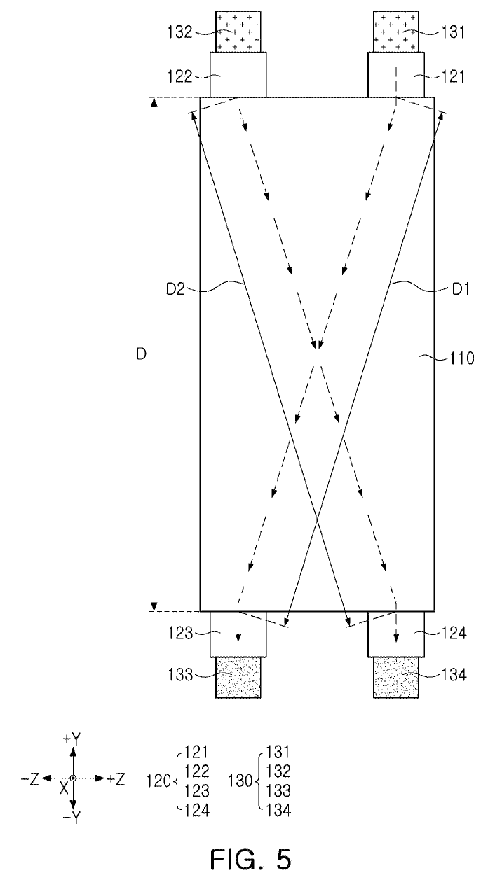

A battery cell 100 according to a second embodiment of the present disclosure will be described with reference to FIG. 5.

FIG. 5 is a top view illustrating the interior of a cell case 150 of a battery cell 100 according to a second embodiment, and is a diagram illustrating a flow of current.

The description of the electrode assembly 110, the electrode lead 130, and the cell case 150 of the first embodiment described with reference to FIGS. 1 to 4, excluding differences, may be applied to the battery cell 100 according to the second embodiment.

When viewed in a first direction (X), when a straight-line distance from a bundle of first cathode non-coated portions 121 to a bundle of first anode non-coated portions 123 is D1, a straight-line distance from a bundle of second cathode non-coated portions 122 to a bundle of second anode non-coated portions 124 is D2, and a length of the electrode assembly 110 is D, D1 > D and D2 > D may be satisfied.

The straight-line distance from the bundle of first cathode non-coated portions 121 to the bundle of first anode non-coated portions 123 may be a length of a straight line connecting a point at which the bundle of first cathode non-coated portions 121 and a cathode plate are connected and a point at which the bundle of first anode non-coated portions 123 and an anode plate are connected when viewed in the first direction (X). In other words, when viewed in the first direction (X), it may be a length of a straight line connecting a point at which the bundle of first cathode non-coated portions 121 begins to be exposed externally of the electrode plate EP and a point at which the bundle of first anode non-coated portions 123 begins to be exposed externally of the electrode plate EP. The length of the electrode assembly 110 may refer to the length of the plurality of electrode plates EP. D1 and/or D2 may be greater than D.

That is, when viewed in the first direction (X), the bundle of first cathode non-coated portions 121 and the bundle of first anode non-coated portions 123 may be disposed diagonally adjacent to each other. In addition, the bundle of second cathode non-coated portions 122 and the bundle of second anode non-coated portions 124 may be disposed diagonally adjacent to each other.

A flow of current may vary, depending on the location of the bundle of non-coated portions (or electrode lead 130). A line connecting the bundle of cathode non-coated portions and the bundle of anode non-coated portions (or cathode lead and anode lead) may be the shortest path through which current flows. Heat generation may occur around the path through which current flows. In particular, a significant temperature increase can occur around the bundle of non-coated portions. When the bundle of first cathode non-coated portions 121 and the bundle of first anode non-coated portions 123 or the bundle of second cathode non-coated portions 122 and the bundle of second anode non-coated portions 124 are disposed diagonally adjacent to each other, a length of the path through which current flows can increase. In this case, an internal heat generation phenomenon of the electrode assembly 110 may be more evenly distributed. When the internal temperature of the electrode assembly 110 becomes more uniform, the flow of current may be maintained evenly.

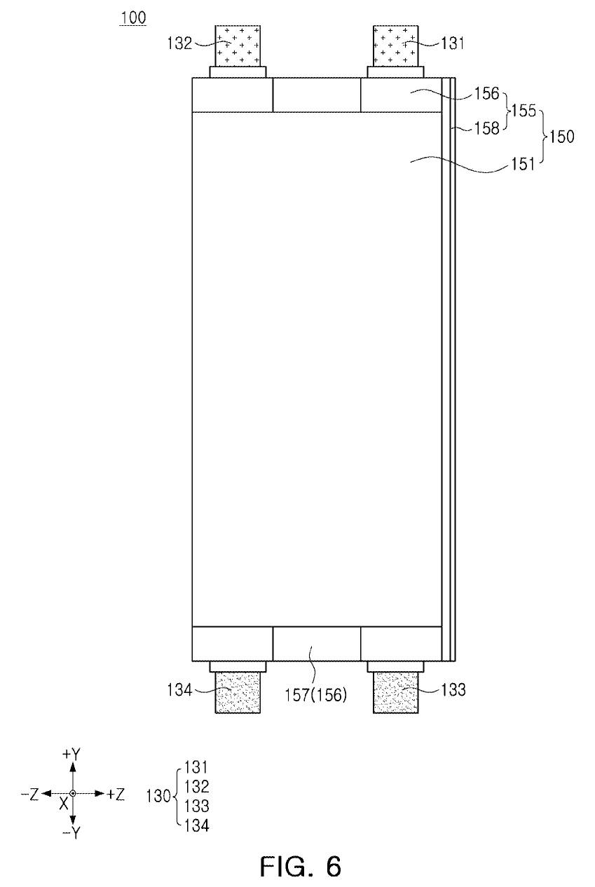

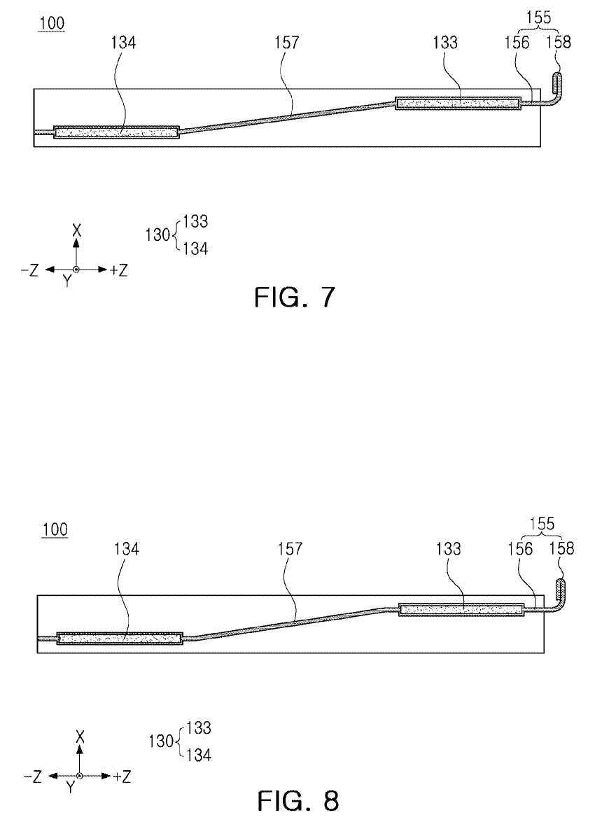

A battery cell 100 according to a third embodiment of the present disclosure will be described with reference to FIGS. 6 and 7.

FIG. 6 is a top view of a battery cell 100 according to a third embodiment, and FIG. 7 is a side view of the battery cell 100 illustrated in FIG. 6.

The description of the electrode assembly 110, the electrode lead 130, and the cell case 150 of the first embodiment described with reference to FIGS. 1 to 4, excluding differences, may be applied to the battery cell 100 according to the third embodiment.

The cell case 150 may include an electrode receiving portion 151 in which the electrode assembly 110 is received, and a sealing portion 155 sealing at least a portion of a circumference of the electrode receiving portion 151. The sealing portion 155 may include a first sealing portion 156 sealing a surface in which the electrode lead 130 is disposed, and a second sealing portion 158 sealing a surface in which the electrode lead 130 is not disposed. The first sealing portion 156 may include an inclined portion 157 forming a slope.

The sealing portion 155 may include a first sealing portion 156 in which an electrode lead is located and a second sealing portion 158 in which an electrode lead is not located. A portion of the electrode lead 130 may be drawn or exposed externally of the cell case 150. In order to increase a sealing degree of the first sealing portion 156 in a position in which the electrode lead 130 is drawn and simultaneously secure an electrical insulation state, the electrode lead 130 may be covered by an insulating film. The insulating film is formed of a film material thinner than the electrode lead 130, and may be attached to both surfaces of the electrode lead 130. Meanwhile, in FIG. 1, a cell case 150 having a structure in which a single sheet of exterior material is folded to form a sealing portion 155 on three surfaces is illustrated, but the shape of the cell case 150 is not limited thereto.

The first sealing portion 156 may include an inclined portion 157 forming a slope. Here, “forming a slope” may mean that a sealing portion 155 is formed in a shape, which is not parallel to a wide surface of the electrode lead 130. Alternatively, it may mean that it is not parallel to a third direction (Z). The inclined portion 157 may be formed between a first cathode lead 131 and a second cathode lead 132 or between a first anode lead 133 and a second anode lead 134. For example, when the first cathode lead 131 and the second cathode lead 132 or the first anode lead 133 and the second anode lead 134 are disposed at different heights of the electrode assembly 110, an inclined portion 157 may be formed to seal between the first cathode lead 131 and the second cathode lead 132. When a slope is formed, the sealing performance of the cell case 150 may be improved.

For example, a first sealing portion 156 between the first cathode lead 131 and the second cathode lead 132 may be formed entirely of an inclined portion 157 forming a slope. In this case, a wider sealing area may be secured, and the slope of the inclined portion 157 may be formed gently. Forming a gentle slope may be advantageous in a sealing process. Similarly, a first sealing portion 156 between the first anode lead 133 and the second anode lead 134 may be formed entirely of an inclined portion 157 forming a slope. In this case, a wider sealing area may be secured, and a slope of the inclined portion 157 may be formed gently. Forming a gentle slope may be advantageous during the sealing process. When a shape or an angle of the inclined portion 157 between the first cathode lead 131 and the second cathode lead 132 and between the first anode lead 133 and the second anode lead 134 are the same, the manufacturing process may be simplified and efficient. However, this does not necessarily have to be the same, and may be appropriately modified as needed. The inclined portion 157 of the present disclosure may be formed in various ways depending on the distance or height difference between the electrode leads 130.

A battery cell 100 according to a fourth embodiment of the present disclosure will be described with reference to FIG. 8.

FIG. 8 is a side view of a battery cell 100 according to a fourth embodiment.

The description of the electrode assembly 110, the electrode lead 130, and the cell case 150 of the first embodiment described with reference to FIGS. 1 to 4, excluding differences, may be applied to the battery cell 100 according to the fourth embodiment.

The description of the cell case 150 described with reference to FIG. 7, excluding the differences, may be applied to the battery cell 100 according to the fourth embodiment.

An inclined portion 157 may be formed to be spaced apart from a first cathode lead 131 and a second cathode lead 132 or a first anode lead 133 and a second anode lead 134.

For example, based on the direction shown in FIG. 8, the inclined portion 157 may be formed in a section between a point, spaced apart from the first cathode lead 131 in a +Z direction by a certain distance and a point, spaced apart from the second cathode lead 132 in a -Z direction by a certain distance. In other words, the inclined portion 157 may not be formed in a region within a certain distance from each of the first cathode lead 131 and the second cathode lead 132.

As described above, when the inclined portion 157 is formed starting from a position, spaced apart from the electrode lead 130 by a certain distance, peripheral portions of the first cathode lead 131 and the second cathode lead 132 may be sealed more precisely and uniformly, thereby improving the sealing performance. In the above descriptions, the first cathode lead 131 and the second cathode lead 132 were described as examples, the above description can be applied in the same manner to the inclined portion 157 formed between the first anode lead 133 and the second anode lead 134.

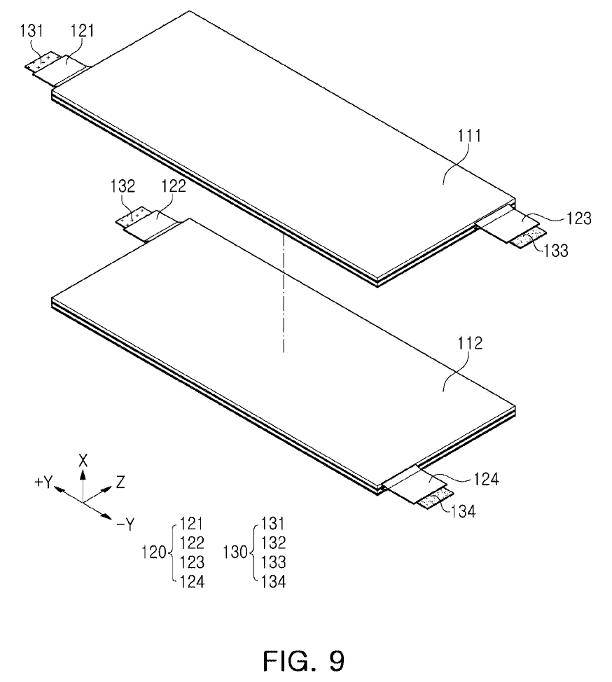

Referring to FIG. 9, a battery cell 100 including a first electrode assembly 111 and a second electrode assembly 112 according to an embodiment of the present disclosure will be described.

FIG. 9 is a perspective view illustrating a first electrode assembly 111 and a second electrode assembly 112 according to an embodiment.

The description of the first embodiment regarding the electrode assembly 110, the electrode lead 130, and the cell case 150 described with reference to FIGS. 1 to 4, excluding differences, may be applied to a battery cell 100 including a first electrode assembly 111 and a second electrode assembly 112 according to an embodiment.

The first electrode assembly 111 may include a plurality of electrode plates EP arranged in a first direction (X), and a bundle of first cathode non-coated portions 121 and a bundle of first anode non-coated portions 123, drawn from the plurality of electrode plates EP. The second electrode assembly 112 may include a plurality of electrode plates EP arranged in a first direction (X), and a bundle of second cathode non-coated portions 122 and a bundle of second anode non-coated portions 124, drawn from the plurality of electrode plates EP. A first electrode assembly 111 and a second electrode assembly 112 may be accommodated inside the cell case 150. The first electrode assembly 111 and the second electrode assembly 112 may be arranged in the first direction (X).

A first electrode assembly 111 and a second electrode assembly 112 may be accommodated inside the cell case 150. The first electrode assembly 111 and the second electrode assembly 112 may be arranged in the first direction (X).

Each of the bundle of first cathode non-coated portions 121 and the bundle of first anode non-coated portions 123 of the first electrode assembly 111 may be electrically connected to a first cathode lead 131 and a first anode lead 133, each of the bundle of second cathode non-coated portions 122 and the bundle of second anode non-coated portions 124 of the second electrode assembly 112 may be electrically connected to a second cathode lead 132 and a second anode lead 134, and the first cathode lead 131, the second cathode lead 132, the first anode lead 133, and the second anode lead 134 may be exposed externally of the cell case 150.

The first electrode assembly 111 and the second electrode assembly 112 may have a structure in which they are manufactured separately and then stacked. Such a structure can minimize bending of the non-coated portion disposed on the outside of the first electrode assembly 111 or the second electrode assembly 112 while maintaining the thickness of the cell case 150, reduce the separation distance (see L in FIG. 3) inside the cell case 150, and improve the energy density. In addition, by reducing a difference in stress applied to the non-coated portion disposed on the outside of the first electrode assembly 111 or the second electrode assembly 112 and the non-coated portion disposed on the inside thereof, damage to the non-coated portion may be prevented, and the stability of the battery cell 100 may be improved.

Meanwhile, the first electrode assembly 111 and the second electrode assembly 112 may have the same structure. For example, the first electrode assembly 111 and the second electrode assembly 112 may be manufactured through the same manufacturing process, and have substantially the same shape. However, an embodiment thereof is not limited thereto, and may be modified as needed. For example, the first electrode assembly 111 may be formed to be thicker than the second electrode assembly 112.

The first cathode lead 131 and the second cathode lead 132 may be exposed externally of the cell case 150 from one side of the cell case 150 in a second direction (Y), a length direction of the cell case 150, and the first anode lead 133 and the second anode lead 134 may be exposed externally of the cell case 150 from the other side of the cell case 150 in the second direction (Y).

The first cathode lead 131 may be disposed on one side of the first electrode assembly 111 in the length direction (second direction) (Y), and the first anode lead 133 may be disposed on the other side of the first electrode assembly 111 in the length direction. The second cathode lead 132 may be disposed on one side of the second electrode assembly 112 in the length direction, and the second anode lead 134 may be disposed on the other side of the second electrode assembly 112 in the length direction. For example, based on the direction illustrated in FIG. 9, the first cathode lead 131 and the second cathode lead 132 may be disposed in the +Y direction, and the first anode lead 133 and the second anode lead 134 may be disposed in the -Y direction. When disposed as described above, a cathode may be disposed on one side of the cell case 150 in the length direction, and an anode may be disposed on the other side of the cell case 150. In this case, the cathode and the anode may be easily distinguished, thereby facilitating connection and management with an external device.

When viewed in the first direction (X), when a straight-line distance from the bundle of first cathode non-coated portions 121 to the bundle of first anode non-coated portions 123 is D1, a straight-line distance from the bundle of second cathode non-coated portions 122 to the bundle of second anode non-coated portions 124 is D2, and a length of the first electrode assembly 111 and the second electrode assembly 112 is D, D1 > D and D2 > D may be satisfied.

When viewed in the first direction (X), the straight-line distance from the bundle of first cathode non-coated portions 121 to the bundle of first anode non-coated portions 123 may be a length of a straight line connecting a point at which the bundle of first cathode non-coated portions 121 and a cathode plate are connected and a point at which the bundle of first anode non-coated portions 123 and an anode plate are connected. In other words, when viewed in the first direction (X), the straight-line distance may be a length of a straight line connecting a point at which the bundle of first cathode non-coated portions 121 begins to be exposed and a point at which the bundle of first anode non-coated portions 123 begins to be exposed. The length of the electrode assembly 110 may refer to a length of a plurality of electrode plates EP. D1 and/or D2 may be greater than D.

That is, when viewed in the first direction (X), the bundle of first cathode non-coated portions 121 and the bundle of first anode non-coated portions 123 may be disposed to be adjacent to each other in a diagonal position of the first electrode assembly 111. In addition, the bundle of second cathode non-coated portions 122 and the bundle of second anode non-coated portions 124 may be disposed to be adjacent to each other in a diagonal position of the second electrode assembly 112.

A flow of current may vary, depending on the location of the bundle of non-coated portions (or electrode lead 130). A line connecting the bundle of cathode non-coated portions and the bundle of anode non-coated portions (or cathode lead and anode lead) may be the shortest path through which current flows. Heat generation may occur around the path through which current flows. In particular, a significant temperature increase can occur around the bundle of non-coated portions. When the bundle of first cathode non-coated portions 121 and the bundle of first anode non-coated portions 123, or the bundle of second cathode non-coated portions 122 and the bundle of second anode non-coated portions 124 are disposed diagonally, adjacent to each other, the path through which current flows may be longer. In this case, localized heat generation within the first electrode assembly 111 and the second electrode assembly 112 may be further alleviated.

In addition, when the first electrode assembly 111 and the second electrode assembly 112 are stacked, when viewed in the first direction (X), the path through which current flows may be configured to have an X-shape (see FIG. 5). That is, the path through which current flows between the bundle of first cathode non-coated portions 121 and the bundle of first anode non-coated portions 123 of the first electrode assembly 111 and the path through which current flows between the bundle of second cathode non-coated portions 122 and the bundle of second anode non-coated portions 124 of the second electrode assembly 112 may be disposed to intersect each other. In this case, generation of heat generated inside the electrode assembly 110 due to the flow of current may be more evenly distributed. That is, the first electrode assembly 111 and the second electrode assembly 112 may be arranged so that the respective bundles of non-coated portions do not overlap.

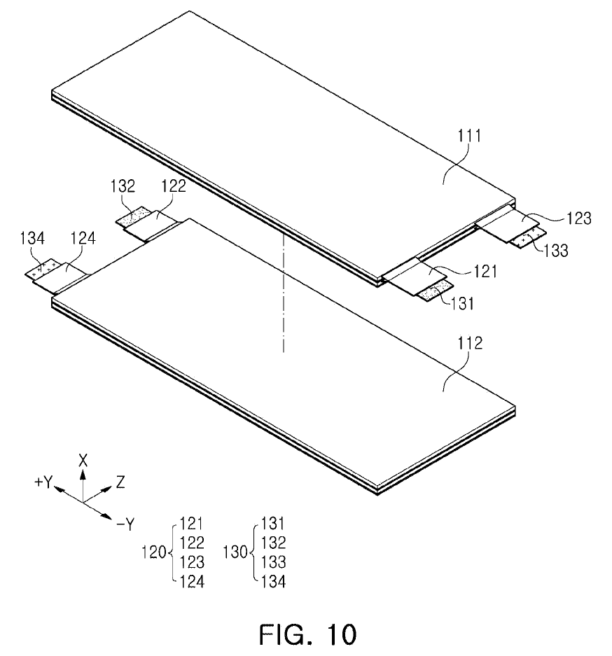

Referring to FIG. 10, a battery cell 100 including a first electrode assembly 111 and a second electrode assembly 112 according to another embodiment of the present disclosure will be described.

FIG. 10 is a perspective view illustrating a first electrode assembly 111 and a second electrode assembly 112 according to another embodiment.

The description of the first embodiment regarding the electrode assembly 110, the electrode lead 130, and the cell case 150 described with reference to FIGS. 1 to 4, excluding differences, may be applied to a battery cell 100 including a first electrode assembly 111 and a second electrode assembly 112 according to another embodiment.

The description of the first electrode assembly 111 and the second electrode assembly 112 according to an embodiment described with reference to FIG. 9 may be applied to a first electrode assembly 111 and a second electrode assembly 112 according to another embodiment.

A first cathode lead 131 and a first anode lead 133 may be exposed externally from one side of the cell case 150 in a second direction (Y), a length direction of the cell case 150, and a second cathode lead 132 and a second anode lead 134 may be exposed externally from the other side of the cell case 150 in the second direction (Y).

A first cathode lead 131 and a first anode lead 133 may be disposed on one side of the first electrode assembly 111 in a length direction (second direction) (Y). A second cathode lead 132 and a second anode lead 134 may be disposed on the other side of the second electrode assembly 112 in the length direction (second direction) (Y). Based on the direction shown in FIG. 10, a first cathode lead 131 and a first anode lead 133 may be disposed in a -Y direction, and a second cathode lead 132 and a second anode lead 133 may be disposed in a +Y direction. That is, a first cathode lead 131 and a first anode lead 133 may be disposed side by side on one side of the cell case 150 in a length direction of the cell case 150. In addition, a second cathode lead 132 and a second anode lead 134 may be disposed side by side on the other side of the cell case 150 in the length direction of the cell case 150. That is, a cathode and an anode may be disposed together on both sides of the cell case 150 in the length direction. This allows for a variety of electrical connection methods with external devices and enhances design freedom.

The first cathode lead 131 and the first anode lead 133 may be disposed at the same height. The first cathode lead 131 and the first anode lead 133 may be disposed at the same height on one side of the first electrode assembly in the second direction (Y). The second cathode lead 132 and the second anode lead 134 may be disposed at the same height. The second cathode lead 132 and the second anode lead 134 may be disposed at the same height on the other side of the second electrode assembly in the second direction (Y). In other words, the first cathode lead 131 and the first anode lead 133, or the second cathode lead 132 and the second anode lead 134 may be drawn on the same horizontal plane of the cell case 150. In this case, a process of forming the first sealing portion 156 may be simplified, and the efficiency of the sealing process of the cell case 150 may be improved.

The above description regarding the disposition of the first cathode lead 131, the first anode lead 133, the second cathode lead 132, and the second anode lead 134 is merely an example, and may be disposed in various ways as needed.

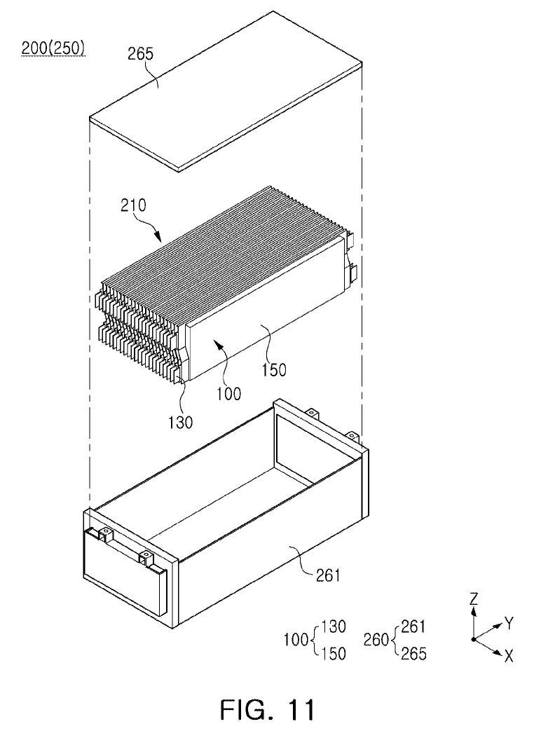

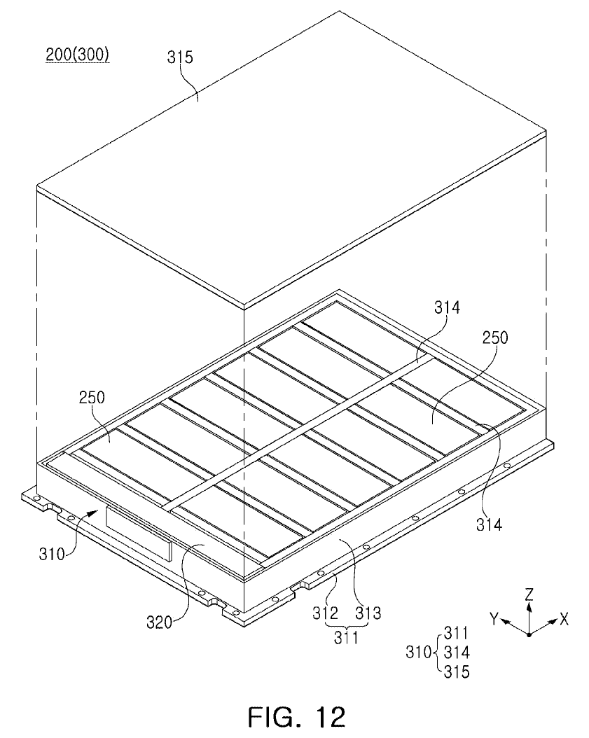

Hereinafter, a battery device 200 including a cell assembly 210 will be described with reference to FIGS. 11 and 12.

FIG. 11 is an exploded perspective view of a battery module 250 according to an embodiment.

A battery device 200 according to an embodiment may include a cell assembly 210 including a plurality of battery cells 100 and a housing 220 accommodating the cell assembly 210.

The description of one battery cell 100 with reference to FIGS. 1 to 10 may be applied to each of a plurality of battery cells 100.

The battery device 200 of the present disclosure is defined as including a cell assembly 210 and a housing 220, and a shape and structure of the battery device 200 may be variously changed. For example, the battery device 200 of the claim may include a battery module 250 illustrated in FIG. 11.

Referring to FIG. 11, the battery module 250 according to an embodiment may include a cell assembly 210 and a module housing 260 accommodating the cell assembly 210.

The cell assembly 210 may have a shape in which a plurality of battery cells 100 are arranged in a specific direction. In an embodiment, the cell assembly 210 may be arranged with wide surfaces thereof facing each other. For example, the cell assembly 210 may be arranged in a first direction (X). However, if necessary, the cell assembly 210 may also be stacked in a gravitational direction (i.e., third direction) (Z). The cell assembly 210 may include the battery cells 100 described with reference to FIGS. 1 to 10.

As an example, each battery cell 100 may be configured as a pouch-type battery cell 100 in which an electrode assembly 110 is accommodated within a pouch. Each battery cell 100 may include an electrode lead 130 exposed externally of the pouch. The electrode lead 130 may include a first cathode lead 131, a second cathode lead 132, a first anode lead 133, and a second anode lead 134.

A housing 220 of the battery device 200 may include a module housing 260. The module housing 260 may have a structure covering at least a portion of the cell assembly 210. The module housing 260 may form at least a portion of the exterior of the battery module 250.

The module housing 260 may have various shapes or divided structures. For example, the module housing 260 may be configured to include a module housing body 261 having a cross-sectional shape with one side open, and a module cover 265 that is combined with the module housing body 261 to form an internal space.

A cell assembly 210 may be disposed inside the module housing 260. At least one surface comprising the module housing 260 may function as a heat dissipation plate dissipating heat generated from the battery cells 100 externally. At least a portion of the module housing 260 may be composed of a material having high thermal conductivity, such as a metal.

Meanwhile, in FIG. 11, it is illustrated that the module housing 260 has a structure surrounding the entire outer surface of the cell assembly 210, but the module housing 260 may also be configured so that at least one surface of the cell assembly 210 is exposed externally. For example, the module housing 260 may also have a configuration not covering a lower surface of the cell assembly 210.

FIG. 12 is an exploded perspective view of a battery pack 300 according to an embodiment.

Referring to FIG. 12, a battery pack 300 according to an embodiment may include a plurality of battery modules 250 and a pack housing 310 accommodating the plurality of battery modules 250. The description of the battery module 250 described in FIG. 11 may be applied to the battery module 250 of FIG. 12.

The battery device 200 of the present disclosure may include a battery pack 300 as illustrated in FIG. 12, a battery pack having a cell-to-pack structure including a plurality of cells, or the like.

A housing 220 of the battery device 200 may include a pack housing 310. The pack housing 310 may accommodate components installed in the battery pack 300, such as a battery module 250. The pack housing 310 may include a pack housing body 311 supporting the battery module 250 and a pack cover 315 covering the pack housing body 311. The pack housing body 311 may include a bottom member 312 and a side wall 313. The pack housing 310 may include a partition wall 314 crossing a space in which the battery device 200 is installed. For example, a receiving space of the pack housing 310 may be divided into a plurality of spaces by a partition wall 314. The partition wall 314 may be installed across the receiving space to reinforce the rigidity of the pack housing 310.

The battery pack 300 may include a battery control unit 320 for controlling the battery module 250. The battery control unit 320 may be disposed within the pack housing 310. The battery control unit 320 may include a battery management system (BMS). The configuration of the battery control unit 320 is well known in various forms, so a detailed description thereof will be omitted. In an embodiment, the battery control unit 320 may be referred to as a processor.

As set forth above, according to an embodiment of the present disclosure, a difference in stress applied to a non-coated portion disposed on the outside of an electrode assembly and stress applied to a non-coated portion disposed on the inside thereof may be reduced.

According to an embodiment of the present disclosure, short-circuits in a non-coated portion may be limited or prevented.

According to an embodiment of the present disclosure, the energy density of a battery cell may be improved by reducing a separation distance, a gap from an end of an electrode assembly in a length direction to a bundle of non-coated portions.

According to an embodiment of the present disclosure, the stability of a battery cell may be improved by alleviating localized concentrated heat generation within an electrode assembly.

Only specific examples of implementations of certain embodiments are described. Variations, improvements and enhancements of the disclosed embodiments and other embodiments may be made based on the disclosure of this patent document.

The above description is merely an example of applying the principles of the present disclosure, and other configurations may be included without departing from the scope of the present disclosure. Furthermore, some components of the above-described embodiments may be omitted, and the embodiments may be implemented in combination with each other.

What is claimed is:

1. A battery cell, comprising:
an electrode assembly including a plurality of electrode plates arranged in a first direction, and a plurality of bundles of non-coated portions, drawn from the plurality of electrode plates;
a cell case having the electrode assembly accommodated therein; and
an electrode lead electrically connected to the plurality of bundles of non-coated portions,
wherein the plurality of bundles of non-coated portions include a bundle of first cathode non-coated portions, a bundle of second cathode non-coated portions, a bundle of first anode non-coated portions, and a bundle of second anode non-coated portions,
the electrode lead includes a first cathode lead connected to the bundle of first cathode non-coated portions, a second cathode lead connected to the bundle of second cathode non-coated portions, a first anode lead connected to the bundle of first anode non-coated portions, and a second anode lead connected to the bundle of second anode non-coated portions, and
the first cathode lead, the second cathode lead, the first anode lead, and the second anode lead are exposed externally of the cell case.

2. The battery cell of claim 1, wherein the bundle of first cathode non-coated portions and the bundle of second cathode non-coated portions are formed at different heights in the first direction, and
the bundle of first anode non-coated portions and the bundle of second anode non-coated portions are formed at different heights in the first direction.

3. The battery cell of claim 1, wherein in a second direction, a length direction of the cell case, the bundle of first cathode non-coated portions and the bundle of second cathode non-coated portions are disposed on one side of the electrode assembly, and
in the second direction, the bundle of first anode non-coated portions and the bundle of second anode non-coated portions are disposed on the other side of the electrode assembly.

4. The battery cell of claim 1, wherein the bundle of first cathode non-coated portions and the bundle of second cathode non-coated portions are formed to be spaced apart from each other in a third direction, a width direction of the cell case, when viewed in the first direction, and
the bundle of first anode non-coated portions and the bundle of second anode non-coated portions are formed to be spaced apart from each other in the third direction, when viewed in the first direction.

5. The battery cell of claim 1, wherein, when viewed in the first direction, the first cathode lead and the second cathode lead are disposed to not overlap each other and the first anode lead and the second anode lead are disposed to not overlap each other.

6. The battery cell of claim 1, wherein, when viewed in the first direction, when a straight-line distance from the bundle of first cathode non-coated portions to the bundle of first anode non-coated portions is D1, a straight-line distance from the bundle of second cathode non-coated portions to the bundle of second anode non-coated portions is D2, and a length of the electrode assembly is D, the following formula is satisfied,
D1 > D, D2 > D.

7. The battery cell of claim 1, wherein the cell case includes an electrode receiving portion in which the electrode assembly is received, and a sealing portion sealing at least a portion of a circumference of the electrode receiving portion, and
the sealing portion includes a first sealing portion sealing a surface in which the electrode lead is disposed, and a second sealing portion sealing a surface in which the electrode lead is not disposed,
wherein the first sealing portion includes an inclined portion forming a slope.

8. The battery cell of claim 7, wherein the inclined portion is formed between the first cathode lead and the second cathode lead or the first anode lead and the second anode lead.

9. The battery cell of claim 8, wherein the inclined portion is formed to be spaced apart from the first cathode lead and the second cathode lead or the first anode lead and the second anode lead.

10. A battery cell, comprising:
a first electrode assembly including a plurality of electrode plates arranged in a first direction, and a bundle of first cathode non-coated portions and a bundle of first anode non-coated portions, drawn from the plurality of electrode plates;
a second electrode assembly including a plurality of electrode plates arranged in a first direction, and a bundle of second cathode non-coated portions and a bundle of second anode non-coated portions, drawn from the plurality of electrode plates; and
a cell case having the first electrode assembly and the second electrode assembly accommodated therein,
wherein the first electrode assembly and the second electrode assembly are arranged in the first direction,
the bundle of first cathode non-coated portions and the bundle of first anode non-coated portions of the first electrode assembly are electrically connected to a first cathode lead and a first anode lead, respectively,
the bundle of second cathode non-coated portions and the bundle of second anode non-coated portions of the second electrode assembly are electrically connected to a second cathode lead and a second anode lead, respectively, and
the first cathode lead, the second cathode lead, the first anode lead, and the second anode lead are exposed externally of the cell case.

11. The battery cell of claim 10, wherein the first cathode lead and the second cathode lead are exposed externally from one side of the cell case in a second direction, a length direction of the cell case, and
the first anode lead and the second anode lead are exposed externally from the other side thereof in the second direction.

12. The battery cell of claim 11, wherein, when viewed in the first direction, when a straight-line distance from the bundle of first cathode non-coated portions to the bundle of first anode non-coated portions is D1, a straight-line distance from the bundle of second cathode non-coated portions to the bundle of second anode non-coated portions is D2, and a length of the first electrode assembly and the second electrode assembly is D, the following formula is satisfied,
D1 > D, D2 > D.

13. The battery cell of claim 10, wherein the first cathode lead and the first anode lead are exposed externally from one side of the cell case in a second direction, a length direction of the cell case, and
the second cathode lead and the second anode lead are exposed externally from the other side thereof in the second direction.

14. A battery device, comprising:
a cell assembly including a plurality of battery cells; and
a housing having the cell assembly accommodated therein,
wherein at least one of the plurality of battery cells includes:
an electrode assembly including a plurality of electrode plates arranged in a first direction, and a plurality of bundles of non-coated portions, drawn from the plurality of electrode plates;
a cell case having the electrode assembly accommodated therein; and
an electrode lead electrically connected to the plurality of bundles of non-coated portions,
wherein the plurality of bundles of non-coated portions include a bundle of first cathode non-coated portions, a bundle of second cathode non-coated portions, a bundle of first anode non-coated portions, and a bundle of second anode non-coated portions,
the electrode lead includes a first cathode lead connected to the bundle of first cathode non-coated portions, a second cathode lead connected to the bundle of second cathode non-coated portions, a first anode lead connected to the bundle of first anode non-coated portions, and a second anode lead connected to the bundle of second anode non-coated portions, and
the first cathode lead, the second cathode lead, the first anode lead, and the second anode lead are exposed externally of the cell case.
